(19) United States
(12) Patent Application Publication
(10) Pub. No.: US 2023/0172367 A1
(43) Pub. Date: Jun. 8, 2023

(54) FOAM MATTRESS WITH HIGH RECOVERY FUNCTION

(71) Applicant: Zinus Inc., Gyeonggi-do (KR)

(72) Inventor: Younjae LEE, Gyeonggi-do (KR)

(21) Appl. No.: 18/052,164

(22) Filed: Nov. 2, 2022

Related U.S. Application Data
(63) Continuation-in-part of application No. PCT/CN2021/100002, filed on Jun. 15, 2021.

(30) Foreign Application Priority Data
Jun. 29, 2020 (CN) 202010608105.0
Jun. 29, 2020 (CN) 202021234280.X

(51) Int. Cl. A47C 27/14; A47C 27/15; B68G 7/00

(52) U.S. Cl. CPC A47C 27/144; A47C 27/15; B68G 7/00

(57) ABSTRACT

The present disclosure provides a mattress assembly. The mattress comprises a top foam layer, a convoluted foam layer and a plurality of foam pieces. The foam pieces are applied with adhesive bonding agent and secured the top foam layer and the convoluted foam layer together.

### CROSS-REFERENCE

This application is a continuation-in-part application of International Application No. PCT/CN2021/100002, filed Jun. 15, 2021, which claims the benefit of and priority to Chinese Patent Application No. 202010608105.0 filed on Jun. 29, 2020 and Chinese Patent Application No. 202021234280.x filed on Jun. 29, 2020, each of which is incorporated herein by reference in its entirety for all purposes.

### BACKGROUND

Nowadays, mattresses (e.g., foam mattresses) are often foldable or compressible for easy packaging, storage (e.g., in a warehouse, in a user's storage area,) and shipping (e.g., when shipping to a user). After being folded and compressed for packaging, storage, and shipping, the recovery property may be compromised.

### SUMMARY

It is desired to have mattresses with light weight and high recovery property, for example, at the time when taking out from the package and deploying for use. The present disclosure provides a mattress assembly with high recovery function. Foldable mattress assemblies may comprise one or more convoluted layers. A convoluted layer has one or both surfaces that have a plurality of openings (e.g., recesses) defined by a plurality of spaced-apart protrusions. A convoluted foam layer is sometimes referred to as egg carton foam because of the similarity of shape. A convoluted foam layer may help reduce the amount of foam that is needed to construct a foam mattress with a certain thickness, and thus reduce the total weight of a foam mattress. Additionally, the openings defined by the plurality of spaced-apart protrusions improve the breathability of the foam mattress, and thus improve the conform level for end users (consumers). For at least these reasons, one or more convoluted foam layers may be employed to construct a foam mattress.

To create a foam mattress with one or more of the convoluted foam layers, an adhesive bonding agent (e.g., glue) may be applied between different layers to secure the foam layers together. Traditionally, the adhesive bonding agent is applied on the spaced-apart protrusions of the convoluted foam layer, then an upper layer is placed on top of the convoluted foam layer. This process may lead to a number of undesirable consequences. First, it is generally not easy to control the amount of the adhesive bonding agent applied on an uneven surface (convoluted surface), and may lead to more than necessary adhesive bonding agent applied to the surface. It also causes the whole mattress assembly to be heavier than necessary due to the weight of the excess amount of the adhesive bonding agent. Second, the bonded portion (e.g., consisting of the peak of the protrusions) may end up being larger than necessary due to the excess amount of the adhesive bonding agent and the subsequent process of rolling and packaging, and thus hinder the breathability and recovery property. Third, the time needed for drying the adhesive bonding agent may be longer than necessary due to the excess amount of the adhesive bonding agent used, and it is thus not economically desirable. Therefore, the conventionally available foam mattress with convoluted layers may compromise on efficiency, weight, transportability and packability.

Recognized herein are various limitations with foam mattress assembly with one or more convoluted layers. The present disclosure aims to address the shortcomings and technical disadvantages of commercially available foam mattress assemblies by providing a foam mattress assembly that is light weighted and can be easily packaged into a compact volume for storage and shipping/transport, without compromising the structural stability, and can improve end user comfort (e.g., better breathability, better recovery property, etc.)

In one aspect, the present disclosure provides a foam mattress assembly, comprises: a top foam layer including top and bottom surfaces, wherein the top foam layer spans an entire width and length of the foam mattress assembly; a first convoluted foam layer including a convoluted top surface and a bottom surface, wherein the convoluted top surface comprises a plurality of openings defined by a plurality of spaced-apart raised protrusions, wherein the first convoluted foam layer spans the entire width and length of the foam mattress assembly; a plurality of foam pieces, wherein each of the plurality of foam pieces includes a first surface and a second surface, wherein the first surface and the second surface of the foam pieces are applied with an adhesive bonding agent, and wherein the plurality of foam pieces are positioned apart between the top foam layer and the convoluted top surface, wherein the adhesive bonding agent secures the bottom surface of the top foam layer and a subset of the plurality of spaced-apart raised protrusions of the first convoluted layer together.

In some embodiments, a length of each of the plurality of foam pieces is equal to or less than the length of the mattress assembly. In some embodiments, a length of each of the plurality of foam pieces is equal to or less than the width of the mattress assembly. In some embodiments, the foam mattress assembly further comprising, a second convoluted foam layer positioned below the first convoluted foam layer. In some embodiments, a second plurality of foam pieces are positioned apart between the first convoluted foam layer and the second convoluted foam layer, wherein each of the second plurality of foam pieces are applied with the adhesive bonding agent, and wherein the adhesive bonding agent secures the bottom surface of the first convoluted foam layer and a subset of the plurality of spaced-apart raised protrusions of the second convoluted foam layer together. In some embodiments, the plurality of foam pieces is deposited parallel with one another. In some embodiments, the plurality of foam pieces is deposited parallel to one of a plurality of edges of the foam mattress assembly. In some embodiments, the plurality of foam pieces is deposited in an array. In some embodiments, the plurality of foam pieces is made of high density foam. In some embodiments, the plurality of foam pieces is uniform in thickness.

In an aspect, the present disclosure provides a method of making a mattress assembly, comprises: preparing a top foam layer including top and bottom surfaces, wherein the top foam layer spans an entire width and length of the foam mattress assembly; preparing a first convoluted foam layer including a convoluted top surface and a bottom surface, wherein the convoluted top surface comprises a plurality of openings defined by a plurality of spaced-apart raised protrusions, wherein the first convoluted foam layer spans the entire width and length of the foam mattress assembly; preparing a plurality of foam pieces, wherein each of the plurality of foam pieces includes a first surface and a second surface; applying an adhesive bonding agent on the first surface and the second surface of the foam pieces; positioning the foam pieces apart between the top foam layer and the convoluted top sur-face of the first convoluted layer, wherein the adhesive bonding agent secures the bottom surface of the top foam layer and a subset of the plurality of spaced-apart raised protrusions of the first convoluted layer together; and drying the adhesive bonding agent for a predetermined amount of time.

In some embodiments, a length of each of the plurality of foam pieces is equal to or less than the length of the mattress assembly. In some embodiments, a length of each of the plurality of foam pieces is equal to or less than the width of the mattress assembly. In some embodiments, the method further comprises preparing a second convoluted foam layer including a convoluted top surface and a bottom surface, wherein the convoluted top surface comprises a plurality of openings defined by a plurality of spaced-apart raised protrusions, preparing a second plurality of foam pieces; applying the adhesive bonding agent on the first surface and the second surface of the foam pieces; and positioning the second plurality of foam pieces apart between the first convoluted foam layer and the second convoluted foam layer, wherein the adhesive bonding agent secures the bottom surface of the first convoluted foam layer and a subset of the plurality of spaced-apart raised protrusions of the second convoluted foam layer together. In some embodiments, the plurality of foam pieces is deposited parallel with one another. In some embodiments, the plurality of foam pieces is deposited parallel to one of a plurality of edges of the foam mattress assembly. In some embodiments, the plurality of foam pieces is deposited in an array. In some embodiments, the plurality of foam pieces is made of high density foam. In some embodiments, the plurality of foam pieces is uniform in thickness.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A-1C schematically illustrate a traditional mattress assembly.

FIG. 2A schematically illustrates a perspective view of a mattress assembly of the present disclosure.

FIG. 2B schematically illustrates a top perspective view of the mattress assembly of FIG. 2A.

FIG. 3A schematically illustrates a perspective view of a mattress assembly of the present disclosure.

FIG. 3B schematically illustrates a top perspective view of the mattress assembly of FIG. 3A.

FIG. 4A schematically illustrates a perspective view of a mattress assembly of the present disclosure.

FIG. 4B schematically illustrates a top perspective view of the mattress assembly of FIG. 4A.

FIG. 5A schematically illustrates a perspective view of a mattress assembly of the present disclosure.

FIG. 5B schematically illustrates a top perspective view of the mattress assembly of FIG. 5A.

FIG. 6A schematically illustrates a perspective view of a mattress assembly of the present disclosure.

FIG. 6B schematically illustrates a top perspective view of the mattress assembly of FIG. 6A.

FIG. 7 illustrates a comparison of recovery rates among traditional mattress assemblies and the mattress assembly provided by present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure addresses the shortcomings and technical disadvantages of traditional foam mattress assembly with convoluted layers, which may compromise weight, breathability, recovery property, transportability, and packageability of the mattress.

Disclosed herein are various examples of mattress assemblies and methods of making the same that are improved on breathability, weight, recovery property, and can be packed into a compact volume for storage or shipping/transport.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

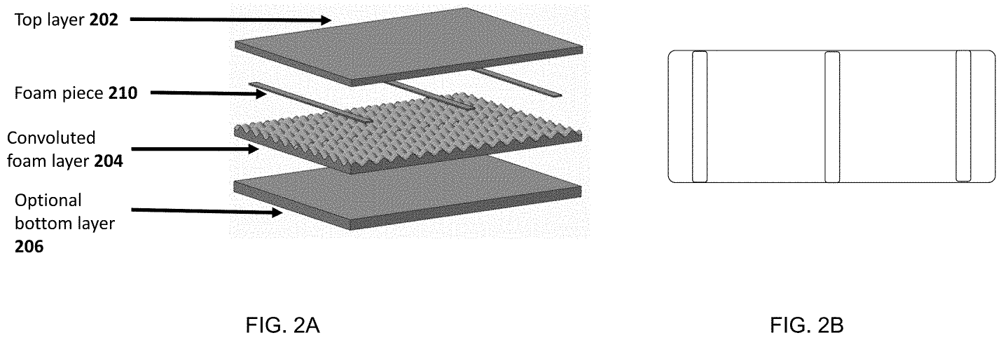

FIG. 2A schematically illustrates a perspective view of a mattress assembly of the present disclosure. FIG. 2B schematically illustrates a top perspective view of the mattress assembly of FIG. 2A. As shown in FIG. 2A, a form mattress assembly may include a top layer 202, one or more convoluted layer(s) 204, an optional bottom layer 206, and one or more foam pieces 210. In some embodiments, the top layer 202, the one or more convoluted layer(s) 204, the optional bottom layer 206, and the one or more foam pieces 210 may be made of foam material. The foam material may comprise, for example, a polyurethane foam, a polyethylene foam, a cross-linked polyethylene foam, or a reticulated foam. The foam material may comprise any type of open cell foam. Alternatively, the foam material may comprise any type of closed cell foam.

One example of a traditional mattress assembly may include using flat foam layers and securing them together to make a mattress. Because the planar surfaces of foam layers are secured together, this type of mattress suffers from bad breathability and bad recovery rate when deployed for use.

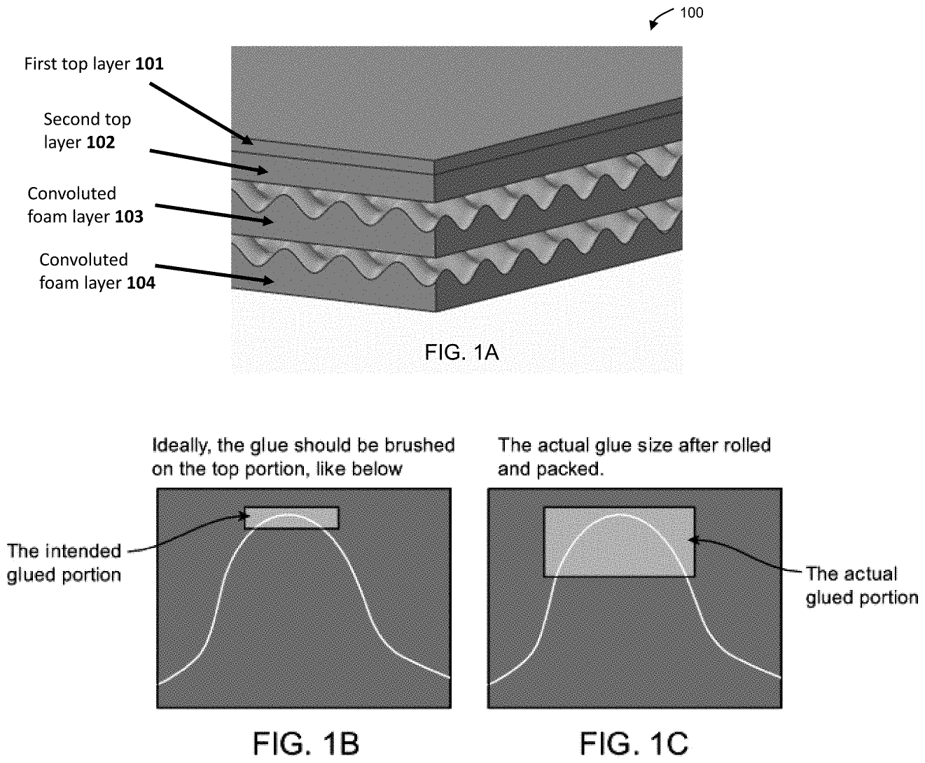

Another example of a traditional mattress assembly 100 is illustrated in FIG. 1A. The mattress assembly 100 includes a first top layer 101, a second top layer 102, a convoluted foam layer 103, and a convoluted foam layer 104. To make the mattress assembly 100, the process generally starts with placing the lowest layer (in this case, the convoluted foam layer 104) on a planar ground, then brushing glue or other type of adhesive bonding agents on the peaks (top portion) of each of the protrusion portions of the convoluted foam layer 104, as shown in FIG. 1B. Next, the process continues to place an upper layer (in this case, the convoluted foam layer 103) on top of the convoluted foam layer 104. Next, the process may be repeated for additional upper layers to secure the layers together by the adhesive bonding agent. As shown in FIG. 1C, due to various reasons, the glued portion of the tips of the protrusion portions of the convoluted foam layer 104 or 103 may be larger than intended. These reasons include i) the weight of the combined upper layers applied downward toward the lower layers may cause the shape of the tip of the protrusion to be squeezed flatter than intended; ii) when performing the subsequent steps, usually including pressing and rolling for packaging of the mattress assembly, sometimes the adhesive bonding agent is not dried completely; the insufficient dryness level of the adhesive bonding agent combined with the pressure that comes from the packaging process, may cause the actual bonded area (e.g., glued portion) larger than the intended bonded portion. Additionally, because the dimensions of the surface areas of different layers (i.e., the convoluted foam layer 104, the convoluted foam layer 103, the second top layer 102, and the first top layer 101) are generally the same for a mattress assembly, when placing one layer on top of another layer, the air flow between the layers is very minimal, even considering that there are openings defined by the space-apart protrusions of a convoluted layer may allow a limited amount of air flows through. This property exacerbates the problem associated with the insufficient dryness level of the adhesive bonding agent, and may lead to production inefficiency caused by the period of time needed to fully dry a mattress before it can be packaged and shipped, which may in turn cause more in-house storage space of the production facility and longer turnaround time. Furthermore, because the glued portions are larger than the intended glued portion, the recovery property of the mattress assembly is deteriorated. When being deployed for use, the larger than intended glued portion may cause the mattress to not be fully recovered to the intended thickness. This also led to poor breathability of the mattress, because the opens (i.e., valley portion of the convoluted layer) may be compressed to be smaller than intended by the larger glued portions.

To address the shortcomings and technical disadvantages of the traditional foam mattress assembly, the present disclosure provides a foam mattress assembly that uses foam pieces (e.g., foam strips) to secure different layers together. FIG. 2A schematically illustrates a perspective view of a mattress assembly of the present disclosure. FIG. 2B schematically illustrates a top perspective view of the mattress assembly of FIG. 2A. As shown in FIG. 2A, a form mattress assembly may include a top layer 202, one or more convoluted layer(s) 204, an optional bottom layer 206, and one or more foam pieces 210. In some embodiments, the top layer 202, the one or more convoluted layer(s) 204, the optional bottom layer 206, and the one or more foam pieces 210 may be made of foam material. The foam material may comprise, for example, a polyurethane foam, a polyethylene foam, a cross-linked polyethylene foam, or a reticulated foam. The foam material may comprise any type of open cell foam. Alternatively, the foam material may comprise any type of closed cell foam.

In some embodiments, the top layer 202, the one or more convoluted layer(s) 204, the optional bottom layer 206, and the one or more foam pieces 210 are foam layers, wherein foam may include memory foam, gel foam, reflex foam, latex rubber foam, and the like. In some embodiments, to make a mattress assembly, the top layer 202, the one or more convoluted layer(s) 204, and the optional bottom layer 206, are secured together by an adhesive bonding agent. As shown in FIG. 2A, one or more foam pieces 210 are prepared. In some embodiments, the foam pieces 210 may be made of high density foam. In some embodiments, high density foam may be a foam with firmness of 15, 20, 25, 30, 35, 40, 45, 50, 55, 60, 65, 70, 75, 80, 85, or 90 ILD. In some embodiments, high density foam may be a foam with a compression rate of 10%, 15%, 20%, 25%, 30%, 35%, 40%, 45%, 50%, 55%, 60%, 65%, etc. In some embodiments, the foam pieces 210 may be leftover foam material (e.g., leftover foam material from foam layer production or similar process). In some embodiments, the manufacture process of the mattress assembly may start with preparing a plurality of foam layers, wherein the foam layers may include a top foam layer 202 and one or more convoluted foam layers 204. A top foam layer 202 may serve as the top surface of the mattress assembly. In some embodiments, the top foam layer 202 spans an entire width and length of the foam assembly. A convoluted foam layer 204 may include one convoluted surface and one planar surface. In some embodiments, the convoluted foam layer 204 may include two convoluted surfaces (not shown in FIG. 2A). A convoluted surface, as shown in FIG. 2A, may comprise a plurality openings (i.e., valleys) defined by a plurality of spaced-apart protrusions (i.e., peaks). In some embodiments, the convoluted surface may comprise a repeating pattern of peaks and valleys across the entire convoluted surface. In some embodiments, the convoluted surface may comprise a randomly-distributed pattern of peaks and valleys across the entire convoluted surface. The spaced-apart protrusions (i.e., peaks) may take shape of a sinusoidal or bumpy structure. In some embodiments, the spaced-apart protrusions (i.e., peaks) may be bumps spaces in an array, in rows and columns, staggered, concentric, etc. The recessed portions (i.e., valleys, openings) may be defined by the spaced-apart protrusions. In some embodiments, the convoluted surface may comprise a repeating pattern of peaks and valleys across a portion of the entire convoluted surface, and with the rest of the convoluted surface may be planar. In some embodiments, the convoluted surface may comprise a randomly-distributed pattern of peaks and valleys across a portion of the entire convoluted surface, and with the rest of the convoluted surface may be planar.

Next, the mattress manufacture process may proceed to prepare a plurality of foam pieces 210. In some embodiments, the foam pieces may have a surface area that is in rectangle shape. In some embodiments, the foam pieces 210 may have a surface area that is in circle, triangle, and/or square shapes. In some embodiments, the foam pieces 210 may have a surface area that is in pentagon, hexagon, heptagon, octagon, trapezoid, oval, diamond, and/or parallelogram shapes. In some embodiments, the foam pieces 210 may have a surface area that is in a random shape. In some embodiments, a subset of the foam pieces 210 may be in one shape, and other subsets of the foam pieces 210 may be in other shapes. Each of the foam pieces 210 has two surfaces, a first surface and a second surface facing away from each other. In some embodiments, the first and second surfaces may be planar. In some embodiments, one or both of the first and second surfaces of the foam pieces 210 may be convoluted. In some embodiments, the thickness of each individual foam pieces 210 may be uniform across the entire surface area of the foam piece. In some embodiments, the thickness of one or more individual foam pieces 210 may not be uniform, for example, to provide accommodating function when being used to secure foam layers together. In some embodiments, the density of each individual foam pieces 210 is uniform across the body area of the foam piece 210. In some embodiments, the density of each individual foam pieces 210 may not be uniform across the body area of the foam piece 210. In some embodiments, the foam pieces 210 are made of high-density foam. In some embodiments, the foam pieces 210 are made of other types of flexible materials that are with the ability to bend or compress and return to its original shape when the applied force is removed. In some embodiments, the foam pieces 210 share the same flexibility and/or elasticity property with the foam layers (e.g., top layer 202, convoluted layer 204, bottom layer 206, etc.). In some embodiments, the foam pieces 210 may be more or less flexible than the foam layers 202, 204, and/or 206, i.e., the foam pieces 210 have a greater and smaller ratio of strain to stress than the foam layers 202, 204, and/or 206. For example, the foam pieces 210 may have 2 times, 1.5 time, or 1.25 times of the ratio of strain to stress than the foam layers 202, 204, and/or 206. In some embodiments, the foam layers 202, 204, and/or 206 may have a compressivity level that is 10%, 15%, 20%, 25%, 30%, 35%, 40%, 45%, 50%, 55%, 60%, 65%, 70%, 80%, 90% of the compressivity level of the foam pieces 210. In some embodiments, depending on the direction of folding and packaging of the mattress assembly (e.g., folding along the length of the mattress first, then rolling; folding along the width of the mattress first, then rolling, etc.), the manufacture process may select foam pieces 210 that have different shape, flexibility property, material, etc. to accommodate the packaging process and thus provide desire recovery property of the mattress.

Next, the mattress manufacture process may proceed to apply an adhesive bonding agent on both sides (i.e., a first surface and a second surface) of the foam pieces 210. In some embodiments, the adhesive bonding agent may include adhesive glue. Examples of adhesive glue may include wet adhesives, contact adhesives, reactive adhesives, hot-melt adhesives, pressure-sensitive adhesives, etc. In some embodiments, the adhesive bonding agent may include adhesive tapes. Examples of adhesive takes may include cloth tapes, foam tapes, foil tapes, heat-seal tapes, etc. After both surfaces of the foam pieces 210 are applied with the adhesive bonding agent, the manufacture process proceeds to position the foam pieces 210 between the top foam layer 202 and the convoluted layer 204. As shown in FIG. 2A, each of the foam pieces 210 are positioned apart from each other. FIG. 2B illustrates a top perspective view of the mattress assembly, and shows that three (3) foam pieces 210 are positioned apart from each other with the same distance between one another. In some embodiments, the foam pieces 210 may be positioned apart with different distances between one another. In some embodiments, the foam pieces 210 are positioned in parallel with one another. In some embodiments, the foam pieces 210 are positioned not in parallel with one another. As shown in FIG. 2A and FIG. 2B, the length of each of the foam pieces 210 is the same as the width of the mattress assembly. In some embodiments, the length of the foam pieces 210 may be smaller than the mattress assembly (shown and described herein elsewhere). As shown in FIG. 2A and FIG. 2B, the foam pieces 210 are positioned in parallel to one of the edges of the mattress assembly. In some embodiments, the foam pieces 210 is positioned not in parallel to one of the edges of the mattress assembly. As described herein elsewhere, the number of foam pieces, the relative positions between foam pieces, and the distances between foam pieces may vary. When being positioned between the top foam layer 202 and the convoluted layer 204, the adhesive bonding agent applied on the foam pieces may secure the bottom surface of the top foam layer 202 and a subset of the spaced-apart raised protrusion together. That is, only the subset of the spaced-apart raised protrusions (i.e., peaks) of the convoluted foam layer 204 may be in contact with the adhesive bonding agent. This may reduce the amount of adhesive bonding agent needed to secure foam layers together, and provides better air circulation between layers, which reduces the necessary time for drying the adhesive bonding agent, and adds less weight to the mattress assembly.

In some embodiments, there may be additional convoluted layers 204 being positioned below a first convoluted layer 204. The manufacture process may repeat the same process to secure any additional convoluted layer with other layers, with the aid of foam pieces 210 and adhesive bonding agent. In some embodiments, after securing foam layers together, the mattress assembly may be left in place for a certain period of time to allow the adhesive bonding agent to dry. In some embodiments, the period of time to allow the adhesive bonding agent to dry may be 1 hour, 2 hours, 3 hours, 4 hours, 5 hours, 10 hours, 12 hours, 1 day, 2 days, 3 days, 4 days, 5 days, or 10 days. In some embodiments, the period of time to allow the adhesive bonding agent to dry may be 5 minutes, 10 minutes, 20 minutes, 30 minutes, 40 minutes, 50 minutes. The necessary period of time for drying the adhesive bonding agent depends partially on the type of adhesive bonding agent utilized to secure the foam layers. In some embodiments, the manufacture facility may enhance air circulation by improving the air flow in the facility, for example, by utilizing fans, air pumps. In some embodiments, depending on the type of adhesive bonding agent used to secure the foam layers, the manufacture facility may control the humidity to a desired degree.

As shown in FIG. 2A, the bottom layer 206 is optional, and may be replaced by an additional convoluted layer 204. In some embodiments, the convoluted layer 204 may have a bottom planar surface, and the mattress assembly may not have a bottom layer, wherein the bottom planar surface of the convoluted layer 204 may serve as the bottom surface for the mattress assembly.

As shown in FIG. 2A and FIG. 2B, the layout of the foam pieces 210 foam three (3) island area that glues the foam layers together. This may provide better breathability of the mattress assembly when being deployed for use, because the volume of the foam pieces 210 may provide support between foam layers (e.g., top foam layer 202 and convoluted layer 204), and thereby allow better air circulation between these layers.

The foam layers illustrate in FIG. 2A and FIG. 2B are merely examples of the foam layers utilized to manufacture a mattress assembly; any additional layers (e.g., convoluted layer with one convoluted surface, convoluted layer with two convoluted surfaces, planar layers, etc.) may be added to the mattress assembly. The mattress assembly may comprise less than the foam layers illustrated in FIG. 2A and FIG. 2B, for example, a mattress assembly comprises only one convoluted layer and another layer secured together with foam pieces.

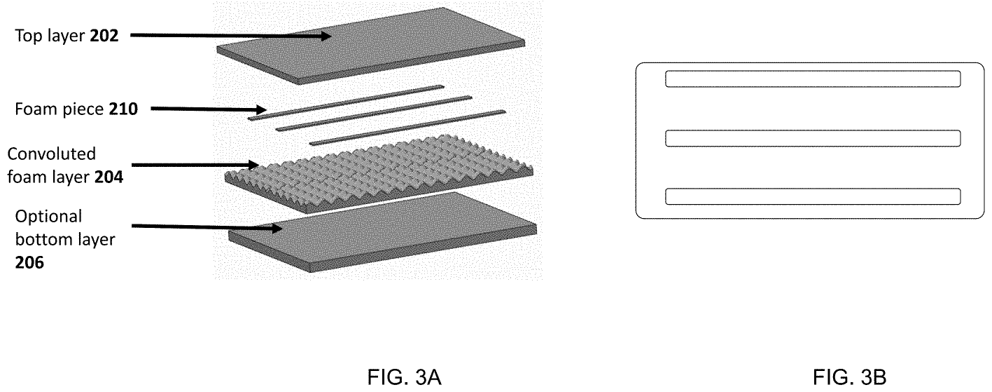

FIG. 3A schematically illustrates a perspective view of a mattress assembly of the present disclosure. FIG. 3B schematically illustrates a top perspective view of the mattress assembly of FIG. 3A. As shown in FIG. 3A and FIG. 3B, the foam pieces 210 adopt a different layout compared to the embodiments illustrated in FIG. 2A and FIG. 2B, wherein the foam pieces 210 extend along the length of the mattress assembly. As shown in FIG. 3A and FIG. 3B, the foam pieces 210 may be parallel to one of the edges of the mattress assembly. In some embodiments, the foam pieces 210 may not be in parallel to any of the edges of the mattress assembly. As shown in FIG. 3A and FIG. 3B, the length of the foam pieces 210 is smaller than the length of the mattress assembly. In some embodiments, the length of the foam pieces 210 is the same as the length of the mattress assembly. In some embodiments, the foam pieces 210 are positioned in parallel with one another. In some embodiments, the foam pieces 210 are positioned not in parallel with one another.

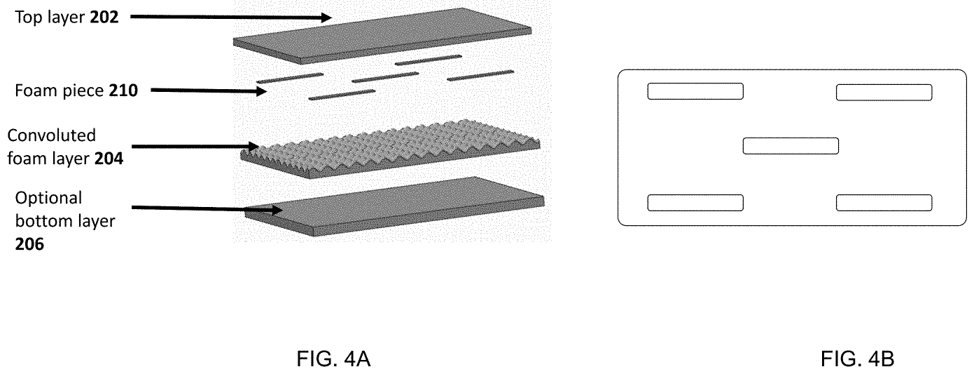

FIG. 4A schematically illustrates a perspective view of a mattress assembly of the present disclosure. FIG. 4B schematically illustrates a top perspective view of the mattress assembly of FIG. 4A. As shown in FIG. 4A and FIG. 4B, the foam pieces 210 adopt a different layout compared to the embodiments illustrated in FIG. 2A, FIG. 2B, FIG. 3A, and FIG. 3B, wherein the foam pieces 210 are positioned in an array. As shown in FIG. 4A and FIG. 4B, the foam pieces 210 may be positioned apart from each other between two foam layers. As shown in FIG. 4A and FIG. 4B, the foam pieces 210 may have a length that is shorter than the length of the mattress assembly. Although the foam pieces 210 are the same size shown in FIG. 4A and FIG. 4B, the foam pieces 210 may be different from one another in dimension.

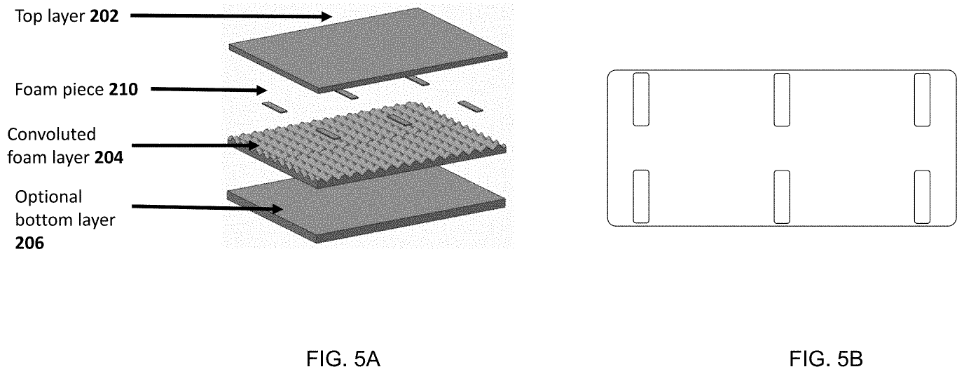

FIG. 5A schematically illustrates a perspective view of a mattress assembly of the present disclosure. FIG. 5B schematically illustrates a top perspective view of the mattress assembly of FIG. 5A. As shown in FIG. 5A and FIG. 5B, the foam pieces 210 adopt a different layout compared to the embodiments illustrated in FIG. 2A, FIG. 2B, FIG. 3A, FIG. 3B, FIG. 4A and FIG. 4B, wherein the foam pieces 210 are positioned in an array of 6 foam pieces 210. As shown in FIG. 5A and FIG. 5B, the foam pieces 210 may be positioned apart from each other between two foam layers, in an array layout of 3 rows and 2 columns. As shown in FIG. 5A and FIG. 5B, the foam pieces 210 may have a length that is shorter than the width of the mattress assembly. Although the foam pieces 210 are the same size shown in FIG. 5A and FIG. 5B, the foam pieces 210 may be different from one another in dimension. Although 6 piece of foam pieces 210 is illustrated in connection with FIG. 5A and FIG. 5B, it should be understood that other number of foam pieces 210 may be utilized to secure foam layers together.

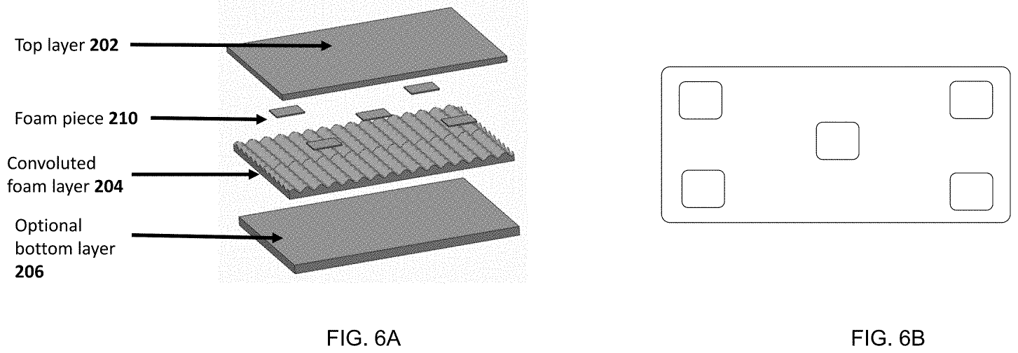

FIG. 6A schematically illustrates a perspective view of a mattress assembly of the present disclosure. FIG. 6B schematically illustrates a top perspective view of the mattress assembly of FIG. 6A. As shown in FIG. 6A and FIG. 6B, the foam pieces 210 adopt a different layout compared to the embodiments illustrated in FIG. 2A, FIG. 2B, FIG. 3A, FIG. 3B, FIG. 4A, FIG. 4B, FIG. 5A and FIG. 5B, wherein the foam pieces 210 are positioned in an array of 5 square foam pieces 210. As shown in FIG. 6A and FIG. 6B, the foam pieces 210 may be positioned apart from each other between two foam layers. As shown in FIG. 6A and FIG. 6B, the foam pieces 210 may have a length that is shorter than the length of the mattress assembly. Although the foam pieces 210 are the same size shown in FIG. 6A and FIG. 6B, the foam pieces 210 may be different from one another in dimension. Although 5 piece of foam pieces 210 is illustrated in connection with FIG. 5A and FIG. 5B, it should be understood that other number of foam pieces 210 may be utilized to secure foam layers together. The foam pieces 210 illustrated in FIG. 6A and FIG. 6B are in square shape. In some embodiments, other shapes of foam pieces 210 may be utilized to secure foam layers together. In some embodiments, the foam pieces 210 may have a surface area that is in circle, triangle, and/or square shapes. In some embodiments, the foam pieces 210 may have a surface area that is in pentagon, hexagon, heptagon, octagon, trapezoid, oval, diamond, and/or parallelogram shapes. In some embodiments, the foam pieces 210 may have a surface area that is in a random shape. In some embodiments, the foam pieces 210 may be in a circle shape to secure more of the spaced-apart protrusions compared to other shapes with the same surface area. In some embodiments, depending on the concentration degrees of the spaced-apart protrusions of the convoluted surface, one or more shapes of the foam pieces 210 may be selected and utilized to secure the foam layers together.

In some embodiments, depending on the subsequent packaging process, a layout of the foam pieces 210 may be selected. For example, depending on the direction of the force that comes from the packaging, one or more layouts of the foam pieces 210 may be selected to accommodate the force. In some embodiments, if the mattress assembly is a twin mattress, i.e., with a length significantly longer than the width of the mattress, the mattress may be compressed and rolled from one end to another end to form a mattress roll for storage and/or transportation. In these embodiments, the layout of the foam pieces 210 may follow the illustrations shown in FIGS. 1A and 1B, to allow the force to be absorbed evenly along the width direction of the foam pieces. Alternatively, the layout of the foam pieces 210 may follow the illustrations shown in FIGS. 2A and 2B, to allow the force to be absorbed evenly along the length direction of the foam pieces 210. In some embodiments, depending on the material of the foam pieces, the layout of the foam pieces 210 may vary to accommodate the flexibility and elasticity of the foam pieces 210 and the foam layers 202 and 204.

In some embodiments, the number of foam pieces may be 6, 7, 8, 9, 10, 11, 12, 13, 14, 15, 20, 25, 30 pieces. In some embodiments, the number of foam pieces 210 may be determined based on the size of the mattress assembly, the packaging process, the material of the foam pieces, etc. In some embodiments, the total area of foam pieces 210 may vary. For example, all the foam pieces 210 may cover at least 10%, 15%, 20%, 25%, 30%, 35%, 40%, 45%, 50%, 55%, 60%, 65%, 70%, 80%, 90% of surface dimension of the mattress assembly to provide sufficient secure force. In some embodiments, the foam pieces 210 may be arranged in parallel to each other. In some embodiments, the foam pieces 210 may be perpendicular to one another.

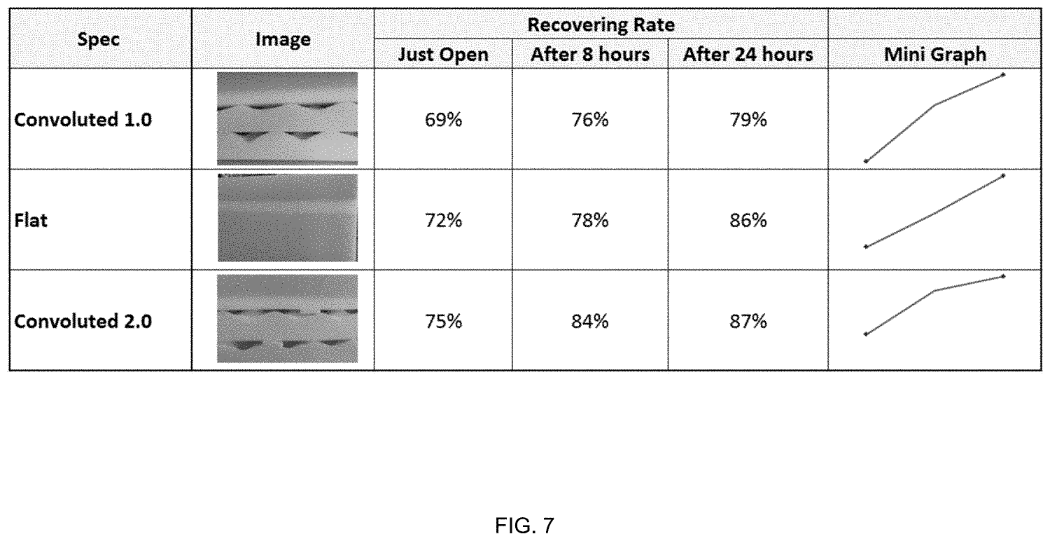

FIG. 7 illustrates a comparison of recovery rates among traditional mattress assemblies and the mattress assembly provided by present disclosure. For the comparison purpose, the three types of mattress assemblies are assembly formations for the same size of mattress (e.g., king, queen, twin, etc.) For flat mattresses (i.e., each foam layer is flat with no convoluted surfaces), the gross weight for this particular mattress is 35.2 kg, wherein the foam material constitutes 27.4 kg, the adhesive bonding agent constitutes 0.557 kg, and the packaging accessories constitute the rest of the total gross weight. For the mattress assembly provided by the present disclosure (i.e., convoluted 2.0 formation), the gross weight for this particular mattress is down to 33.6 kg, wherein the foam material constitutes 25.8 kg, the adhesive bonding agent constitutes 0.223 kg, and the packaging accessories constitute the rest of the total gross weight. Comparing to traditional mattress assemblies, there is a significant reduction of the amount of adhesive bonding agent utilized to secure foam layer together, which is a 60% reduction (0.223 kg comparing to 0.557 kg). Additionally, there is also a 5.8% reduction in the amount of foam that is needed to manufacture this mattress (25.8 kg compared to 27.4 kg) because of the convoluted property of the foam layers. This may in turn provide better breathability and thus greater comfort level of the mattress assembly. The total gross weight is also down by 4.5% (33.6 kg compared to 35.2 kg), which may ease the transportation of the mattress assembly. Although, for the purpose of comparison, a specific size of mattress was used as an example with the specific weights, the weights may vary across different sizes of mattress (e.g., king, queen, twin, etc.). The percentage comparison may provide an understanding of the improvements and benefits of the mattress assembly provided by present disclosure.

Furthermore, as shown in FIG. 7, the recovery rate is improved as well. Many structural features associated with the mattress assembly provided by the present disclosure aid in the better recovery rate. For example, less amount of adhesive bonding agent is utilized to secure foam layers together, which in turn allows less over-bonding portions to be formed. Additionally, because of the reduction in overall weight of the mattress assembly, the downward gravity force applied to the mattress assembly when drying the adhesive bonding agent is also reduced, which may in turn allow more air circulation between the opens (i.e., valleys) of the convoluted surface. That is, it may take less time for the adhesive bonding agent to be completely dried, and the mattress assembly may be less affected by the subsequent packaging process, i.e., less likely to generate a larger than intended bonded portion (e.g., glued-together portion). This may further improve the recovery rate when the mattress is deployed for use.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A foam mattress assembly, comprising:
a top foam layer including top and bottom surfaces, wherein the top foam layer spans an entire width and length of the foam mattress assembly;
a first convoluted foam layer including a convoluted top surface and a bottom surface, wherein the convoluted top surface comprises a plurality of openings defined by a plurality of spaced-apart raised protrusions, wherein the first convoluted foam layer spans the entire width and length of the foam mattress assembly;
a plurality of foam pieces, wherein each of the plurality of foam pieces includes a first surface and a second surface, wherein the first surface and the second surface of the foam pieces are applied with an adhesive bonding agent, and wherein the plurality of foam pieces are positioned apart between the top foam layer and the convoluted top surface, wherein the adhesive bonding agent secures the bottom surface of the top foam layer and a subset of the plurality of spaced-apart raised protrusions of the first convoluted layer together.

2. The foam mattress assembly of claim 1, wherein a length of each of the plurality of foam pieces is equal to or less than the length of the mattress assembly.

3. The foam mattress assembly of claim 1, wherein a length of each of the plurality of foam pieces is equal to or less than the width of the mattress assembly.

4. The foam mattress assembly of claim 1, further comprising, a second convoluted foam layer positioned below the first convoluted foam layer.

5. The foam mattress assembly of claim 4, wherein a second plurality of foam pieces are positioned apart between the first convoluted foam layer and the second convoluted foam layer, wherein each of the second plurality of foam pieces are applied with the adhesive bonding agent, and wherein the adhesive bonding agent secures the bottom surface of the first convoluted foam layer and a subset of the plurality of spaced-apart raised protrusions of the second convoluted foam layer together.

6. The foam mattress assembly of claim 1, wherein the plurality of foam pieces is deposited parallel with one another.

7. The foam mattress assembly of claim 1, wherein the plurality of foam pieces is deposited parallel to one of a plurality of edges of the foam mattress assembly.

8. The foam mattress assembly of claim 1, wherein the plurality of foam pieces is deposited in an array.

9. The foam mattress assembly of claim 1, wherein the plurality of foam pieces is made of high density foam.

10. The foam mattress assembly of claim 1, wherein the plurality of foam pieces is uniform in thickness.

11. A method of making a mattress assembly, comprising:
preparing a top foam layer including top and bottom surfaces, wherein the top foam layer spans an entire width and length of the foam mattress assembly;
preparing a first convoluted foam layer including a convoluted top surface and a bottom surface, wherein the convoluted top surface comprises a plurality of openings defined by a plurality of spaced-apart raised protrusions, wherein the first convoluted foam layer spans the entire width and length of the foam mattress assembly;
preparing a plurality of foam pieces, wherein each of the plurality of foam pieces includes a first surface and a second surface;
applying an adhesive bonding agent on the first surface and the second surface of the foam pieces;
positioning the foam pieces apart between the top foam layer and the convoluted top surface of the first convoluted layer, wherein the adhesive bonding agent secures the bottom surface of the top foam layer and a subset of the plurality of spaced-apart raised protrusions of the first convoluted layer together; and
drying the adhesive bonding agent for a predetermined amount of time.

12. The method of claim 11, wherein a length of each of the plurality of foam pieces is equal to or less than the length of the mattress assembly.

13. The method of claim 11, wherein a length of each of the plurality of foam pieces is equal to or less than the width of the mattress assembly.

14. The method of claim 11, further comprising:
preparing a second convoluted foam layer including a convoluted top surface and a bottom surface, wherein the convoluted top surface comprises a plurality of openings defined by a plurality of spaced-apart raised protrusions,
preparing a second plurality of foam pieces;
applying the adhesive bonding agent on the first surface and the second surface of the foam pieces; and
positioning the second plurality of foam pieces apart between the first convoluted foam layer and the second convoluted foam layer, wherein the adhesive bonding agent secures the bottom surface of the first convoluted foam layer and a subset of the plurality of spaced-apart raised protrusions of the second convoluted foam layer together.

15. The foam mattress assembly of claim 11, wherein the plurality of foam pieces is deposited parallel with one another.

16. The foam mattress assembly of claim 11, wherein the plurality of foam pieces is deposited parallel to one of a plurality of edges of the foam mattress assembly.

17. The foam mattress assembly of claim 11, wherein the plurality of foam pieces is deposited in an array.

18. The foam mattress assembly of claim 11, wherein the plurality of foam pieces is made of high density foam.

19. The foam mattress assembly of claim 11, wherein the plurality of foam pieces is uniform in thickness.
